(19) United States
(12) Patent Application Publication
(10) Pub. No.: US 2024/0050959 A1
(43) Pub. Date: Feb. 15, 2024

(54) METHOD FOR OBTAINING NATURAL RUBBER FROM PLANT MATERIAL

(71) Applicants: Continental Reifen Deutschland GmbH, Hannover (DE); Fraunhofer Gesellschaft zur Förderung der angewandten Forschung e.V., Munich (DE)

(72) Inventors: Carla Recker, Hannover (DE); Frank Behm, Sassen-Trantow (DE); Katharina Herzog, Harsum (DE); Norbert Janczak, Guetzkow (DE); Carsten Venz, Neddemin (DE); Dirk Prüfer, Münster (DE); Christian Schulze Gronover, Muenster (DE)

(73) Assignee: Continental Reifen Deutschland GmbH, Hannover, OT (DE)

(21) Appl. No.: 18/253,015

(22) PCT Filed: Nov. 5, 2021
(86) PCT No.: PCT/EP2021/080710

§ 371 Date: Oct. 30, 2023

(30) Foreign Application Priority Data
Nov. 16, 2020 (DE) 10 2020 214 356.0

(51) Int. Cl. B02C 17/22; B02C 23/08; B02C 17/20

(52) U.S. Cl. CPC B02C 17/22; B02C 23/08; B02C 17/20

(57) ABSTRACT

The invention relates to a process for obtaining natural rubber from plant material containing at least the step of milling the plant material with at least one ball mill comprising milling media. The invention further relates to the natural rubber obtained by this process and to the use of at least one ball mill comprising milling media for milling plant material when obtaining natural rubber from plant material.

In the process, the ball mill has a nonmetallic lining and/or the milling media have at least a nonmetallic surface.

The invention relates to a process for obtaining natural rubber from plant material containing at least the step of milling the plant material with at least one ball mill comprising milling media. The invention further relates to the natural rubber obtained by this process and to the use of at least one ball mill comprising milling media for milling plant material when obtaining natural rubber from plant material.

Many consumer goods of everyday modern life are made of rubber. With regard, here, to possible stress and quality, natural rubber is often superior to synthetically produced rubber. For a long time, natural rubber was mainly obtained from rubber trees of the genus Hevea, in particular from Hevea brasiliensis, a plant species mainly cultivated in Asia.

Recently, searches have been made for suitable alternatives for obtaining rubber, with particular interest in plants that also thrive under the climatic conditions of Central Europe. A known suitable alternative for obtaining natural rubber is the dandelion, especially the Russian dandelion (Taraxacum kok-saghyz). The latter can provide rubber as more than 10% (w/w) of dry matter per plant, and the natural rubber obtained is very similar to that of Hevea brasiliensis.

Processes for obtaining natural rubber from dandelion and other plants and the use of the natural rubber for rubber products, such as tires, are already known.

WO 2018036825 A1 describes a process of the type mentioned at the outset, in which dandelion plant parts are comminuted and/or squeezed to form a pulp and the pulp is separated into a phase high in inulin and low in rubber and a phase high in rubber and low in inulin. The comminution and squeezing can usually be done with a bead or ball mill.

U.S. Pat. No. 814,407 also already describes the use of ball mills for the treatment of rubber-containing plant parts.

Ball mills using cast iron balls or steel balls as milling media in a milling chamber made of sheet steel with wear plates are commonly used.

By means of such ball mills, it is possible to obtain natural rubber which, however, does not always have the desired quality and high aging stability.

It is an object of the invention to provide a process for obtaining natural rubber from plant material containing at least the step of milling the plant material with at least one ball mill comprising milling media which makes it possible to obtain a natural rubber of high quality and improved aging resistance.

This object is achieved according to the invention by the ball mill having a nonmetallic lining and/or the milling media having at least a nonmetallic surface.

It has been found that, surprisingly, when metallic material which can come into contact with the plant material to be milled is dispensed with in the ball mill, it is possible to obtain a natural rubber of a quality that is improved and thus also leads to improved and reproducible products. The natural rubber is especially also distinguished by improved aging behavior (reduced polymer degradation). The suspected reason for this is that, when metallic material is dispensed with, it is not possible for heavy metal ions, which impair rubber stability and quality, to get into the rubber.

Preferably, the nonmetallic lining and/or the nonmetallic surface of the milling media is/are free of heavy metals and/or transition metals, preferably free of cobalt, iron, copper, manganese and nickel, particularly preferably free of iron. Iron has been found to be particularly relevant in relation to impairing aging resistance and should not be present in the form of, for example, soluble salts, even in nonmetallic linings and surfaces.

According to a preferred development of the invention, the nonmetallic lining and/or the nonmetallic surface of the milling media consist(s) of ceramic, glass, minerals, porcelain and/or polymeric materials.

Particularly good results in terms of reduced polymer degradation and thus in terms of aging resistance can be achieved if the nonmetallic lining and/or the nonmetallic surface of the milling media consist(s) of a ceramic material. Ceramic materials are based, for example, on silicate raw materials, oxidic raw materials or nonoxidic raw materials. Preferably, the nonmetallic lining and/or the nonmetallic surface of the milling media consist(s) of an aluminum oxide ceramic containing especially between 90% and 96% aluminum oxide. Corundum (Al₂O₃) can be used, for example.

When designing the ball mill, the lining and the surface of the milling media can be made of different materials which should be as abrasion-resistant as possible. The milling media should have at least a nonmetallic surface. They can, however, also consist entirely of the nonmetallic material.

In order to minimize mutual wear, it has been found to be advantageous if the nonmetallic lining and the nonmetallic surface of the milling media consist of the same material, for example corundum.

At least one ball mill is used in the process according to the invention. It is also possible for multiple ball mills to be used, preferably one after the other with different dimensions, milling media and linings. According to a preferred development of the invention, the ball mill is a drum mill or a tube mill or the ball mills are drum mills and/or tube mills. These mill types allow a continuous process for milling the plant material.

The plant material is milled in the ball mill in the presence of a liquid, preferably water. In this way, the natural rubber can be easily obtained/extracted from the plant material.

In order to be able to easily process the plant material and in order to obtain a natural rubber of highest possible purity, it has been found to be advantageous if the plant material has been cleaned, preferably washed with water, before milling in the ball mill. This removes surface-adherent materials, such as sand, loam and clay. The cleaning can be carried out in customary apparatuses, processes and cleaning substances that are customary for cleaning plant material.

In order to shorten the residence time of the plant material in the ball mill, it has been found to be positive if the plant material has been subjected to precomminution before milling in the ball mill. The precomminution can be carried out by customary chopping or crushing processes, for example by chopping machines, hammer mills or the like.

The process according to the invention can be applied to all plants suitable for obtaining natural rubber. Particularly preferably, the plant material originates from the plant genus dandelion (Taraxacum). The plant material of this genus can be milled particularly well by this process.

In order to obtain a particularly high proportion of natural rubber from the plant material, the plant material originates from the plant species Russian dandelion (Taraxacum kok-saghyz) or offspring (hybrids) thereof.

When using the plant genus dandelion, the entire plant can be milled in the process. Preferably, however, the plant material essentially comprises the roots and the hypocotyl of the dandelion, since these plant parts contain the largest proportion of natural rubber.

The invention also includes the natural rubber obtained by the process. Because of a low content of heavy metal ions, the natural rubber is distinguished by good quality and improved aging resistance. The natural rubber can be used to produce a wide variety of rubber products, preferably tires. Products made from this natural rubber, such as vehicle tires, are distinguished by mechanical and dynamic properties that are good and aging-stable. For this purpose, the natural rubber obtained by the process can be processed like a customary natural rubber obtained from Hevea brasiliensis and together with customary mixture constituents, such as fillers, aging stabilizers, plasticizers, sulfur and vulcanization accelerators, by mixing and vulcanization to form vulcanizates.

The invention further relates to the use of at least one ball mill comprising milling media for milling plant material when obtaining natural rubber from plant material, wherein the ball mill has a nonmetallic lining and/or the milling media have at least a nonmetallic surface.

The invention will now be illustrated in detail by comparative examples and working examples, with Table 1 specifying the linings and milling media used and the analysis results obtained.

1-4 kg of fresh, water-cleaned Russian dandelion roots were boiled in a 5- to 10-fold amount of water for 20 to 60 minutes, separated from the boiling water, and transferred with a 3- to 10-fold amount of fresh water to a ball mill (KM 30, 30 L nominal volume, 30 kg of milling balls (1.5 to 6 cm ball diameter)). The ball/root/water mixture was then ground at a speed of 0.5 to 0.75*n(critical) for 1 to 4 h. The exact milling parameters depend on the root quality (size, etc.), and the optimal milling result is distinguished by the formation of rubber flakes of approx. 0.5 to 5 cm diameter and in a homogeneous plant pulp. At the same time, the lining of the mill and the milling media were varied according to Table 1. The suspensions obtained were, for example, filtered with a perforated plate with a 5 mm hole diameter (other filter screens or devices or grids are also possible and suitable, and flotation can also be used for separation), and the filter cake contains the rubber flakes formed in the milling process. The rubber flakes were washed multiple times with water and then dried at room temperature. The milling balls were able to be separated with the aid of a ball trap when emptying the mill.

The natural rubbers obtained in this way were analyzed with respect to the following parameters:
Iron content (Fe content) of the rubber via the 550° C. ash (100-150 mg) by means of XRF (X-ray fluorescence spectroscopy) is directly in XRF SpectroMicro Sample Cups (6.1 mm ID) with PROLENE film from Spectro with the instrument SPECTRO XEPOS.
Number-average molar mass Mₙ and weight-average molar mass M_{w} of the natural rubber by means of gel permeation chromatography (GPC) with tetrahydrofuran (THF) as eluent against polystyrene standard in accordance with DIN 55672-1

TABLE 1

| | Milling | Fe content of | Mₙ | M_{w} |
|---|---|---|---|---|
| Lining | media | the rubber [%] | [g/mol] | [g/mol] |
| Stainless | Stainless | 0.98 | 270 000 | 1 200 000 |
| steel | steel | | | |
| Stainless | Corundum | 0.11 | 580 000 | 1 900 000 |
| steel | (Al₂O₃) | | | |
| Corundum | Corundum | 0.05 | 680 000 | 2 100 000 |
| (Al₂O₃) | (Al₂O₃) | | | |

Table 1 shows that the use of nonmetallic material as lining and/or for the milling media can distinctly reduce polymer degradation and thus aging of the natural rubber. It is particularly advantageous if the lining and milling media consist of corundum.

1.-15. (canceled)

16. A method for obtaining natural rubber from plant material, the method comprising:
boiling plant material of a rubber containing plant in water for up to 60 minutes;
transferring the boiled plant material into a ball chamber of a ball mill;
forming a nonmetallic lining on milling media;
placing the milling media in the ball chamber;
milling the plant material using the milling media to form natural rubber flakes;
separating the milling media from the rubber flakes;
washing the rubber flakes a plurality of times; and
drying the rubber flakes to obtain natural rubber.

17. The method of claim 16, the ball mill is nonmetallic.

18. The method of claim 16, the milling media is Corundum.

19. The method of claim 16, wherein the nonmetallic lining is/are free of heavy metals and/or transition metals.

20. The method of claim 16, the nonmetallic lining of the milling media is/are free of iron.

21. The method of claim 16, wherein the nonmetallic lining comprises one or more of ceramic, glass, minerals, porcelain and/or polymeric materials.

22. The method of claim 16, wherein the nonmetallic lining comprises an aluminum oxide ceramic.

23. The method of claim 16, wherein the nonmetallic lining and a nonmetallic surface of the milling media consist of the same material.

24. The method of claim 16, wherein the ball mill is a drum mill or tube mill or the ball mills are drum mills and/or tube mills.

25. The method of claim 16, wherein the plant material is milled in the ball mill in the presence of a liquid, preferably water.

26. The method of claim 16, further comprising washing the plant material with water prior to squeezing the plant material.

27. The method of claim 16, further comprising subjecting the plant material to precomminution prior to squeezing the plant material.

28. The method of claim 16, wherein the plant material originates from the plant genus dandelion (Taraxacum).

29. The method of claim 16, wherein the plant material originates from the plant species Russian dandelion (Taraxacum kok-saghyz) or offspring (hybrids) thereof.

30. The method of claim 16, wherein the plant material essentially comprises the roots and the hypocotyl.

31. The method of claim 16, the nonmetallic lining is corundum.

32. The method of claim 16, further comprising obtaining natural rubber having an iron content of 0.05 percent or less.
